(19) United States
(12) Patent Application Publication
(10) Pub. No.: US 2017/0291382 A1
(43) Pub. Date: Oct. 12, 2017

(54) MODULAR RECYCLING APPARATUS.

(71) Applicant: John Labiak, Brigantine, NJ (US)

(72) Inventor: John Labiak, Brigantine, NJ (US)

(21) Appl. No.: 15/478,495

(22) Filed: Apr. 4, 2017

Related U.S. Application Data
(60) Provisional application No. 62/319,349, filed on Apr. 7, 2016.

(51) Int. Cl. B30B 9/32; B29B 17/00; B30B 15/34

(52) U.S. Cl. CPC B30B 9/321; B30B 15/34; B29B 17/0052; B29B 2017/0068

(57) ABSTRACT

A modular recycling apparatus, means for and article of manufacture are disclosed. The various embodiments solve the inherent problems with recycling consumer items such as plastic bottles, aluminum cans and the like, The device enables a bottle or container to undergo a quasi-state change, thereby occupying much less space in its recycled form. As a result, the volume needed for storage is optimized and as such the energy required for transport is reduced by at least an order of magnitude.

### CROSS REFERENCE TO RELATED APPLICATIONS

This application claims the benefit to U.S. Provisional Application No. 62/319,349, filed on Apr. 7, 2016, which application is incorporated herein by reference as if set forth in its entirety.

### FIELD OF THE INVENTION

The invention relates generally to recycling process and, more specifically, to a modular recycling apparatus.

### BACKGROUND

It is reported that making bottles to meet America's demand for bottled water uses more than 17 million barrels of oil annually, enough to fuel 1.3 million cars for a year. Yet, that is not even including the oil used for transportation. The energy wasted using bottled water would be enough to power 190,000 homes. Americans used about 50 billion plastic bottles this past year. However, the U.S.' recycling rate of plastic is only about 23 percent, which means 38 billion water bottles or more than 1 billion dollars are wasted each year.

Compared with lucrative recycling of metal and similar to the low value of glass, plastic polymers recycling is often more challenging due to low density and low value. There are also numerous technical hurdles to overcome when recycling plastic.

### SUMMARY

Various deficiencies of the prior art are addressed by a modular recycling apparatus. One embodiment comprises a body having a transport arrangement attached thereto, said body having a chamber for collecting recycled items and for housing one or more heating elements positioned to source heat energy toward an item being recycled; a compactor element located proximate the chamber of said body and configured to facilitate recycling of different items; and a mode selector attached to said body and communicatively coupled to the compactor element thereby determining the mode of operation of said modular recycling apparatus; wherein the item being recycled undergoes a quasi-state change thereby occupying much less space resulting in optimized volume needed for storage.

Another embodiment comprises an article of manufacture, which includes a body having a transport arrangement attached thereto, said body having a chamber for collecting recycled items and for housing one or more heating elements positioned to source heat energy toward an item being recycled; a compactor element located proximate the chamber of said body and configured to facilitate recycling of different items; and a mode selector attached to said body and communicatively coupled to the compactor element thereby determining the mode of operation of said modular recycling apparatus; wherein the item being recycled undergoes a quasi-state change thereby occupying much less space resulting in optimized volume needed for storage.

### BRIEF DESCRIPTION OF THE DRAWINGS

The teachings of the present invention can be readily understood by considering the following detailed description in conjunction with the accompanying drawings, in which:

FIG. 1 depicts a modular recycling apparatus according to an embodiment; and

FIG. 2A-2C depicts a top perspective view of the modular recycling apparatus according to an embodiment;

To facilitate understanding, identical reference numerals have been used, where possible, to designate identical elements that are common to the Figures.

### DETAILED DESCRIPTION

The invention will be primarily described within the context of particular embodiments; however, those skilled in the art and informed by the teachings herein will realize that the invention is also applicable to other technical areas and/or embodiments,

The illustrative modular recycling apparatus, means for and article of manufacture embodiments described herein are not meant to be limiting. It may be readily understood that certain aspects of the disclosed modular recycling apparatus, means for and article of manufacture can be arranged and combined in a variety of different configurations, all of which are contemplated herein.

Generally speaking, the various embodiments solve the inherent problems with recycling consumer items such as plastic bottles, aluminum cans and the like. The quantity of post-consumption plastics recycled has increased every year since at least 1990 according to various reports, but recycling rates lag far behind those of other items, such as newspaper (about 80%) and corrugated fiberboard (about 70%). Overall, U.S. post-consumption plastic waste for 2008 was estimated at 33.6 million tons; 2.2 million tons (6.5%) were recycled and 2.6 million tons (7.7%) were burned for energy; 28.9 million tons or 85.5% were discarded in landfills. Thus, the advantages of a modular recycling device include: (1) reduce the volume of the plastic bottle close to its pure plastic size thereby resulting in optimized volume needed for storage; (2) transportation cost of the reduced volume is therefore significantly reduced; and (3) increase in the US plastic recycling rate. Plastic bottling is used extensively in today's society. A large percentage of products used in everyday living are packaged in plastic bottles such as juice, soda, olive oil, detergent, nuts, candy, honey, syrup, milk, condiments, vitamins, salad dressing, cleaning products and most of all, water. All use various sizes and types of plastic bottles. In manufacturing plastic bottles, it takes very little plastic to make a single bottle. However, when the bottle is discarded, the volume the bottle occupies may be of an order of magnitude greater than the pure plastic due to empty air space. Stated differently, the volume of the discarded plastic bottling is 100's of times the volume of the actual plastic itself. We are paying to discard air by filling garbage pails, 20-yard containers, etc. with the empty plastic bottles. Transportation of this “air” causes thousands of tons of pollution, added traffic and substantially higher costs than is actually needed if we can get plastic close to its pure plastic size. Society now ships plastic bottles uncrushed to recycling centers all over the country. The bottles are taken in most cases by 20-yard dumpster shipping containers. Each container is filled with bottles uncrushed and take up volume many times their actual plastic content volume. In most cases, the weight of total volume of bottles is only a fraction of the actual weight of the 20-yard containers. Thus, we are shipping “air” within those bottles hundreds of thousands a times a year. The fuel usage is astronomical. Cost to the municipalities is astronomical. Thus, the cost is passed on to the homeowner through taxes. Approximate weight comparison, a 20-yard dumpster weighs approximately 4,750 pounds. The weight of the actual plastic in a plastic water bottle is assumed as 1 oz, Therefore, you would need 76,000 plastic water bottles to equal the weight of a 20-yard dumpster. If we now look at the volume of a plastic water bottle, each 16 oz. water bottles has an approximate volume of 0.3 cubic feet. You can therefore ONLY fit 2,650 bottles into a 20 yard dumpster. The weight of 2,650 plastic water bottles is approximately 165 pounds. The weight of the plastic bottles is only 3% or so of the weight of the container. Society is paying to transport the container hundreds of thousands of times a year. Fuel usage and carbon footprint is huge. Most of the trucks that transport these containers use diesel fuel and get very low gas mileage. If we assume a recycling center is only 50 miles round trip and the gas mileage is 10 miles per gallon, the numbers grow rapidly. Therefore, the solution is to significantly reduce the volume of plastic bottles to a minimum using heat and a mechanical crushing mechanism. The device would reduce the volume of the plastic bottle to a fraction of its uncrushed volume by crushing the bottle, thus removing the air. Therefore, we can now get the weight of the plastic much closer to the weight of the container. Thus, we would reduce the number of trips these containers make each year.

Various embodiments operate to provide a modular recycling apparatus having a body, a compactor element and a mode selector. The device enables a bottle or container to undergo a quasi-state change, thereby occupying much less space in its recycled form. As a result, the volume needed for storage is optimized and as such the energy required for transport is reduced by at least an order of magnitude. For example, the volume the recycled bottle occupies is reduced to nearly 1%.

In one embodiment, modular recycling apparatus 100 is (24) twenty-four inches high and eighteen (18) inches in diameter. In other embodiments, different models are constructed with dimensions commensurate to its end use. For example, the geometry of a residential model can be different from that of the industrial or commercial version. The height is influenced by the size of the bottle. As for the residential model, a homeowner would open the device, place a bottle or number of bottles, preferable of same plastic type in the chamber of the device, close the cover and turn the device on. Based on the recycling mode, the device would then heat the plastic to make plastic malleable enough for a crushing plate to squeeze the plastic in order to remove all the air and leaving just the plastic shell. Once the process has been completed, the device would let the plastic cool down to room temperature and release the lid for opening. The crushed plastic can be safely removed and stored in a container until enough is gathered to send it to the recycling center or put outside for pick up. Temperatures range 200-350 degrees Fahrenheit in order to make any type of plastic malleable enough to crush effectively As for the commercial model, office or business owners would have an employee load a number of bottles, again preferably of same plastic type into the device and the same process as outlined above is repeated. The employee could then dispose of the plastic in a normal fashion, but the volume would be reduced to a fraction. Collections would be reduced to a fraction and savings would be seen over time. The residential model recycles up to five (5) bottles at a time whereas the commercial model recycles up to 20 bottles at a time. This device used in just a few thousand homes would reduce the carbon footprint tremendously.

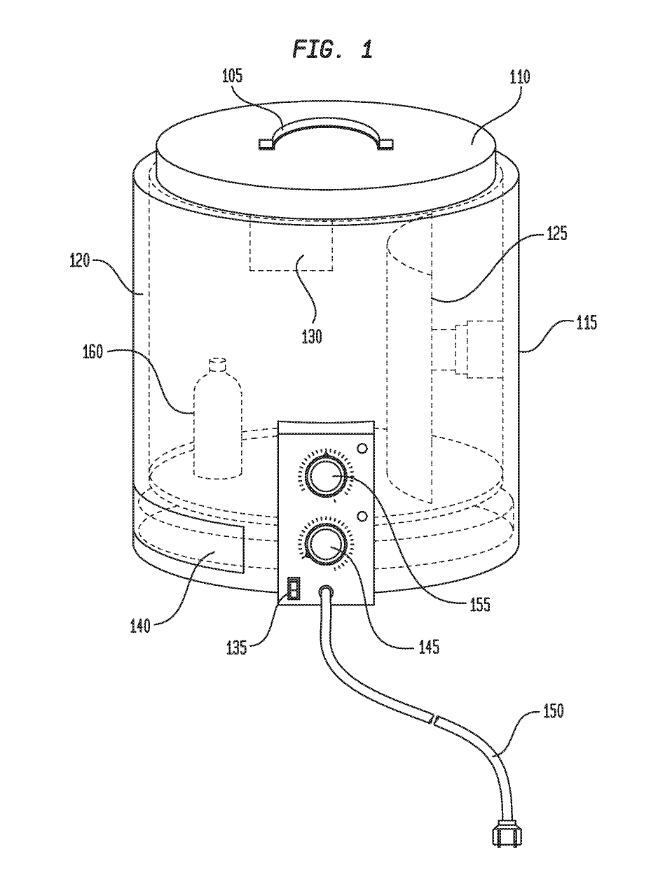

FIG. 1 depicts a front perspective view of a modular recycling apparatus according to an embodiment. Specifically, FIG. 1 depicts a modular recycling apparatus 100 that includes a handle 105, a cover 110, a body 115, a chamber 120, a compactor 125, one or more smart sensors 130, a power switch 135, a battery compartment 140, a mode selector switch 145, a power cord 150 and a capacity volume indicator 155. As shown, handle 105 is attached at the top or proximate end of modular recycling apparatus 100 and together with four (4) level surface enablers (not shown), which are placed at the bottom or distal end of a modular recycling apparatus 100, constitute the transport mechanism for modular recycling apparatus 100. In other embodiments, handle 105 is located on the body of modular recycling apparatus 100 and takes on different shapes and made of different materials. For example, handle 105 can be square and still fulfill the function to transport the device. Cover 110 facilitates the introduction of the item to be recycled into chamber 120. Once the item to be recycled is positioned in chamber 120, the cover is closed and secured in place. In one embodiment, cover 110 is threaded such that it can be securely tightened. In other embodiment, cover 110 is secured using hinges or fasteners placed equidistant on top of body 115. In other embodiments, a self-locking mechanism is employed. The foregoing description of the embodiments of cover 110 has been presented for the purpose of illustration; it is not intended to be exhaustive or to limit cover 110 to the precise forms disclosed. Persons skilled in the relevant art can appreciate that many modifications and variations are possible in light of the above disclosure.

As shown, body 115 is cylindrical. In other embodiments, body 115 is shaped according to several factors. Among them are the placement of handle 105, capacity of chamber 120, placement of the power switch and the like. For example, the shape of the residential model may differ from that of the industrial version. The shape can be round, square or rectangle.

Chamber 120 comprises a landing area, a reservoir, a battery compartment and one or more heating elements, volume capacity indicator. The landing area is where the item to be recycled is deposited. The landing area accommodates various sizes and types of plastic bottles, containers, cans and the like. The reservoir collects the recycled item having undergone a quasi-state change from a bottle, container or can to a reduced form or shape devoid of air. A quasi-state change occurs, because the recycled item no longer retains its original shape or form but instead changes to an irregular shape or form devoid of air. In some embodiments, the recycled item undergoes a state change whereas in other embodiments the recycled item is melted. The battery compartment encases rechargeable batteries and any circuitry required for the type of heating element used. Typically, the power to the device varies between 1-10 VDC. In one embodiment, the device is powered with 5 VDC. Yet, in other embodiments the device is powered with 2.5 VDC. As circuitry for this purpose becomes more efficient, less power may be required or alternative source of power may be employed. The heating elements are electric in some embodiments. Yet, in other embodiments, the heating elements are microwave, infrared. Some embodiments make use of steam, convection heating. Chamber 120 also includes a volume capacity indicator, which indicates the remaining percentage volume of the reservoir. In some embodiment, the indicator mercury type indicator. In other embodiments, a digital indicator is used. When the reservoir is full, a buzzer is sounded. In some embodiments, a blinking indicator is used. Chamber 120 is opaque. In other embodiments, chamber 120 is transparent and decorated.

Compactor 125 when activated moves toward the item deposited in the landing area. In some embodiment, compactor 125 crushes the item. In other embodiments, compactor 125 compacts the material either plastic or aluminum. In some embodiment, the dynamic portion of compactor 125 is made-up of a screw mechanism whereas in other embodiments, the dynamic portion is a hydraulic ram. Compactor 125 includes a multifunctional lid. When modular recycling apparatus 100 is placed in plastic mode of operation, the lid would lock, the one or more heating elements turn on and the ambient temperature would reach around 200 degrees Fahrenheit, not to melt the plastic, but to only make the plastic easier (more malleable) to crush. Once the temperature setting is met, movable crushing plate or dynamic portion of compactor element 125 moves to crush the item being recycled. The movable crushing plate stops based on signaling from a sensor. The movable crushing arm/plate then retracts the lid remains locked until the temperature dropped to around 100 degrees Fahrenheit. The movable crushing plate is inoperable as long as the lid can be opened. In some embodiments, a cooling fan is turned on. Once temperature of the crouched plastic or item being recycled is at a “safe” temperature. The lid would unlock and contents can safely be removed and discarded. When modular recycling apparatus 100 is placed in aluminum mode of operation, the lid would lock, no heating, the moveable crushing plate would move to crush the aluminum contents. Again, the moveable plate would stop at some set point. In some embodiment, the set point is based on force applied, i.e. 300 PSI. In other embodiments, a sensor determines the set point. The crushing plate would retract and the lid would unlock. The recycled item could be safely removed. In some embodiments, the lid is lifted off or removed in order to open same. In other embodiments, the lid is retracted.

Mode selector switch 145 places the device in plastic mode or aluminum mode of operation as articulated above. Mode selector switch 145 is communicatively coupled to compactor element 125 and one or more sensors. In some embodiments, the mode of operation is selected automatically while in other embodiments if the wrong mode is selected, power to the device is turned off. When in plastic mode of operation, a smoke detector or sensor is configured to turn off power to the device in case excessive smoke is detected. In some embodiments, modular recycling apparatus 100 is equipped with sensors allowing the device to communicate over the Internet. Among those sensors are IoT (Internet of Things) sensors, IoMT (Medical Internet of Things/Internet of Medical Things) sensors.

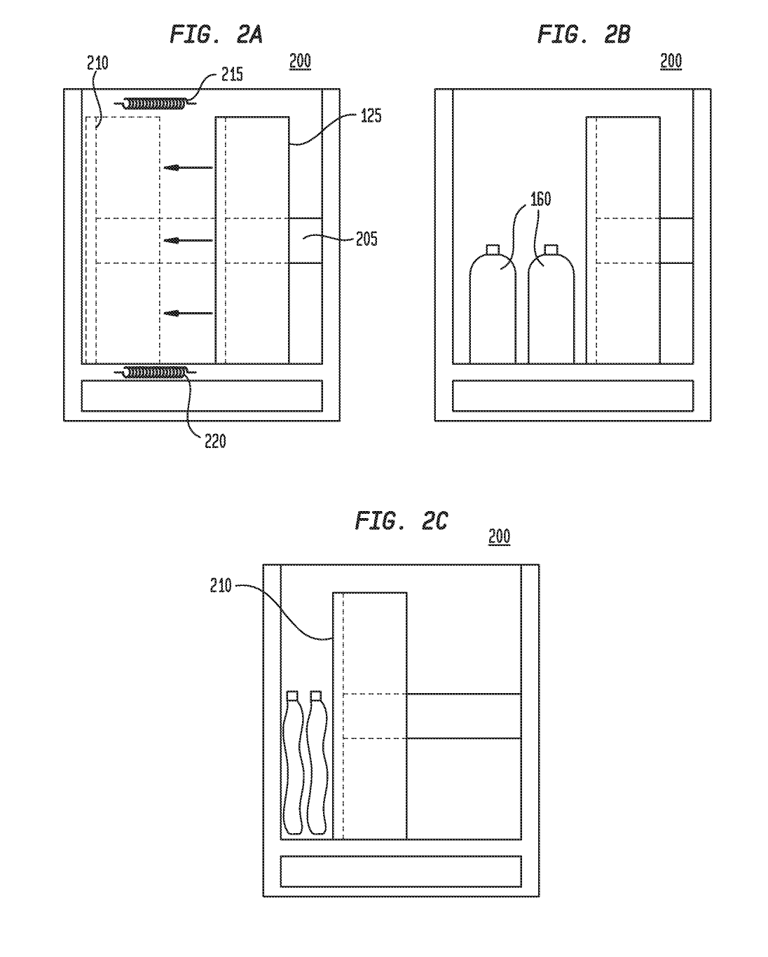

FIG. 2A depicts a top perspective view of the modular recycling apparatus according to an embodiment. As shown, with cover 110 removed, chamber 120 further accommodates one or more heaters 215, 220, movable crushing arm/plate 210 of compactor 125, plunger mechanism 205 of compactor 125 and a reinforced wall 210. In one embodiment, plunger mechanism 205 is a screw mechanism. In other embodiments, plunger mechanism 205 is a hydraulic ram system. Yet, in other embodiments, plunger mechanism 205 is an electric motor. Other embodiments incorporate MEMS (Micro-Electro-Mechanical Systems) for plunger 205 where an accelerometer measures the acceleration of movable crushing arm/plate 210 of compactor 125. For example, tin can, which are much sturdier, would require more force.

FIG. 2B depicts a top perspective view of the modular recycling apparatus according to an embodiment. This view clearly shows the item to be recycled 160. As articulated above, modular recycling apparatus 100 recycles consumer items such as plastic bottles, aluminum cans and the like. A large percentage of products used in everyday living are packaged in plastic bottles such as juice, soda, olive oil, detergent, nuts, candy, honey, syrup, milk, condiments, vitamins, salad dressing, cleaning products and most of all, water. All use various sizes and types of plastic bottles.

FIG. 2C depicts a top perspective view of the modular recycling apparatus according to an embodiment. This view shows movable crushing arm/plate 210 of compactor 125 in its extended position. Harder plastics are heated to make them softer or malleable so that they can be crushed whereas softer water bottles need not be heated. In some embodiments, aluminum cans are not heated whereas in other embodiments heat is modulated when applied to aluminum cans, tin cans.

Although various embodiments, which incorporate the teachings of the present invention have been shown and described in detail herein, those skilled in the art can readily devise many other varied embodiments that still incorporate these teachings. For example, a combination of stamping process and high-speed manufacturing can be used to produce modular recycling apparatus 100.

1. A modular recycling apparatus, comprising:
a body having a transport arrangement attached thereto, said body having a chamber for collecting recycled items and for housing one or more heating elements positioned to source heat energy toward an item being recycled;
a compactor element located proximate the chamber of said body and configured to facilitate recycling of different items; and
a mode selector attached to said body and communicatively coupled to the compactor element thereby determining the mode of operation of said modular recycling apparatus;
wherein the item being recycled undergoes a quasi-state change thereby occupying much less space resulting in optimized volume needed for storage.

2. The apparatus of claim 1, wherein the transport arrangement includes level surface enabler.

3. The apparatus of claim 2, wherein the transport arrangement further comprises one or more handles.

4. The apparatus of claim 1, wherein the chamber includes an indicator providing remaining volume capacity of the chamber.

5. The apparatus of claim 1, wherein the chamber is opaque.

6. The apparatus of claim 1, wherein the chamber is transparent.

7. The apparatus of claim 1, wherein the heating element includes a cooling fan.

8. The apparatus of claim 1, wherein the compactor element includes a multifunctional lid whose state is a function of one of the temperature of the heating element, compactor operation.

9. The apparatus of claim 8, wherein the state of the multifunctional lid is one of open, closed, moving, locked, unlocked.

10. The apparatus of claim 1, wherein the compactor element includes a screw mechanism.

11. The apparatus of claim 1, wherein the compactor element further includes a hydraulic ram.

12. The apparatus of claim 1, wherein the heating element includes electric, microwave, infrared, steam convection.

13. The apparatus of claim 1, wherein the state change of the item being recycled involves air being removed from said item.

14. The apparatus of claim 1, wherein the selector is communicatively coupled to one or more sensors.

15. The apparatus of claim 14, wherein the one or more sensors comprise a smoke detector.

16. The apparatus of claim 14, wherein the one or more sensors comprise a smart sensor, an IoT (Internet of Things) sensor.

17. A modular recycling apparatus, comprising:
means for attaching a transport arrangement to a body having a chamber for collecting recycled items and for housing one or more heating elements positioned to source heat energy toward an item being recycled;
means for attaching a compactor element to said body, said compactor element configured to facilitate recycling of different items; and
means for attaching a mode selector to said body, said selector communicatively coupled to the compactor element thereby determining the mode of operation of said modular recycling apparatus.

18. An article of manufacture, comprising:
a body having a transport arrangement attached thereto, a chamber for collecting recycled items and for housing one or more heating elements positioned to source heat energy toward an item being recycled;
a compactor element attached to said body and configured to facilitate recycling of different items; and
a selector attached to said body and communicatively coupled to the compactor element thereby determining the mode of operation of said modular recycling apparatus;
wherein the item being recycled undergoes a quasi-state change thereby occupying much less space resulting in optimized volume needed for storage.
